(19) United States
(12) Patent Application Publication
(10) Pub. No.: US 2012/0331102 A1
(43) Pub. Date: Dec. 27, 2012

(54) Targeted Content Delivery for Networks

(75) Inventor: Kent Thomas Ertugrul, Paris (FR)

(73) Assignee: Phorm UK, Inc., London (GB)

(21) Appl. No.: 13/585,639

(22) Filed: Aug. 14, 2012

Related U.S. Application Data
(63) Continuation of application No. 11/425,698, filed on Jun. 21, 2006.
Application No. 11/425,698 is a continuation-in-part of application No. 11/377,797, filed on Mar. 15, 2006, now abandoned.
(60) Provisional application No. 60/803,969, filed on Jun. 5, 2006.

(51) Int. Cl. G06F 15/16

(52) U.S. Cl. 709/217

(57) ABSTRACT

Target content delivery from a service provider. The target content delivery includes receiving a content request from a network node, and facilitating delivery of requested content to the network node responsive to the content request. The target content delivery further includes requesting selection information from a different service provider at least in part by reporting to the different service provider one or more characteristics of the requested content, and receiving selection information from the different service provider. In this way, selection information received from the different service provider is used to facilitate delivery of targeted content to the network node.

### CROSS REFERENCE TO RELATED APPLICATIONS

This application is a continuation of U.S. patent application Ser. No. 11/425,698 filed on Jun. 21, 2006, which is a continuation-in-part of U.S. patent application Ser. No. 11/377,797 filed on Mar. 15, 2006, which in turn claims priority to U.S. Provisional Patent Application No. 60/803,969, filed on Jun. 5, 2006, the contents of each of which are hereby incorporated by reference in their entirety for all purposes.

### BACKGROUND AND TECHNICAL FIELD

The Internet allows consumers to view a wide range of content, services and products. This facility allows users to interact with each other in ways not available to older media and new methods of content delivery are evolving to exploit this potential. The present disclosure is directed to targeted content delivery whether it be on the Internet or other suitable network.

### BRIEF DESCRIPTION OF THE DRAWINGS

FIG. 1 depicts a targeted content delivery system and method according to the present description.

FIG. 2 depicts an exemplary computing device that may be used in connection with the systems and methods of the present description.

FIG. 3 depicts a client device operatively connected with a targeted content delivery server system via an internet service provider and the internet.

FIG. 4 depicts an exemplary method for obtaining browsing information and providing targeted content in response to such browsing information.

FIG. 5 depicts an example of how targeted content delivery may be presented on a browser program in accordance with the present description.

FIG. 6 depicts an exemplary method for providing targeted content to a user responsive to the behavior of the user.

FIG. 7 depicts an exemplary network for providing targeted content to a user responsive to the behavior of the user.

FIG. 8 depicts an exemplary method for providing search results to a user.

FIG. 9 depicts an exemplary method for utilizing multi-story branching of content provided to a user.

FIG. 10 depicts an exemplary method for varying a computer based game based on browsing behavior of a user.

FIG. 11 depicts an exemplary method for facilitating social networking based on browsing behavior of one or more users.

### DETAILED DESCRIPTION

As described herein, the collection of user behavior data may be facilitated by one or more service providers to enhance user experience. A service provider may include an internet service provider (ISP), cable provider, telephone provider, wireless provider, or other telecommunications provider. The data collected may include, for example, the browsing behavior with regards to internet web pages requested by and/or delivered to the user's client device, wherein the data collected can be used to enable improved selection and delivery of content tailored specifically to the user. The data collected may also include viewing behavior with regards to other programming such as television, radio or other programming provided via the service provider, such as the amount of time particular content is viewed, the type and/or frequency of content selected by the user, among other user behavior. As one example, online services such as advertising, internet search, dating, blogging, social networking, and/or news can be varied in response to the past and/or present behavior of the user, thereby enabling the content to better address the user's personal interests and preferences. Further, a network of members including service providers, publishers, content providers, and advertisers can be configured to enable sharing of information relating to the behavior of a plurality of users via one or more common protocols. In this manner, a member of the network may submit user behavior information in a standard form that may be processed and disseminated to one or more members of the network. The behavior information may include data indicative of content that may be selected by a specific user and/or content that is provided to the specific user.

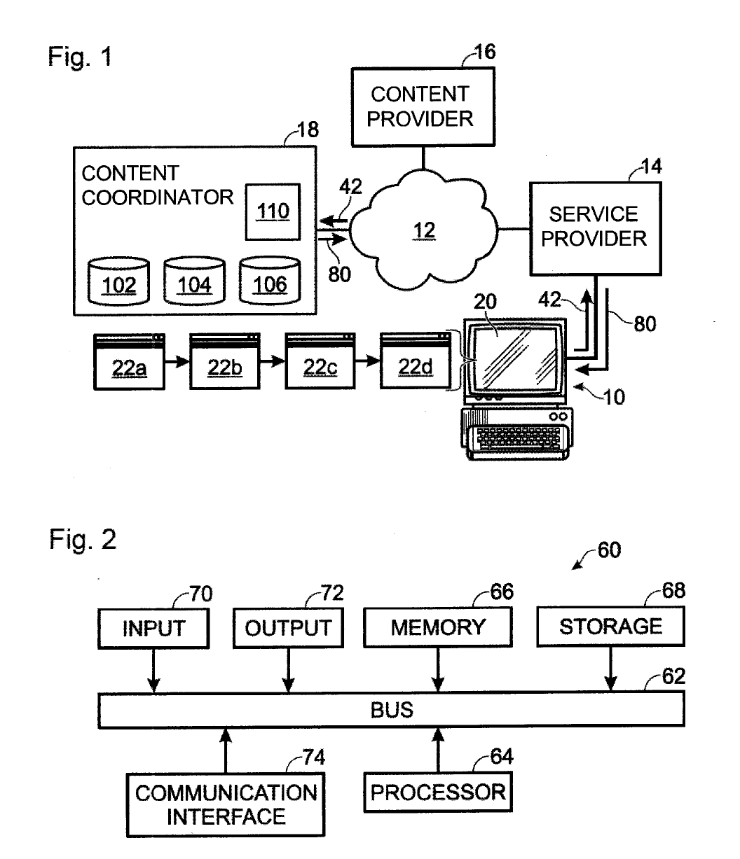

FIG. 1 depicts an example of targeted content delivery according to the present description. As shown, targeted content delivery may be implemented in connection with a computing device interconnected with a network or plurality of networks. The computing device can be said to be located at a node of the network. While some of the present examples will be discussed in the context of the Internet, the Internet is a non-limiting example of one type of suitable network. It should be understood that the present disclosure may be equally applicable to other suitable networks.

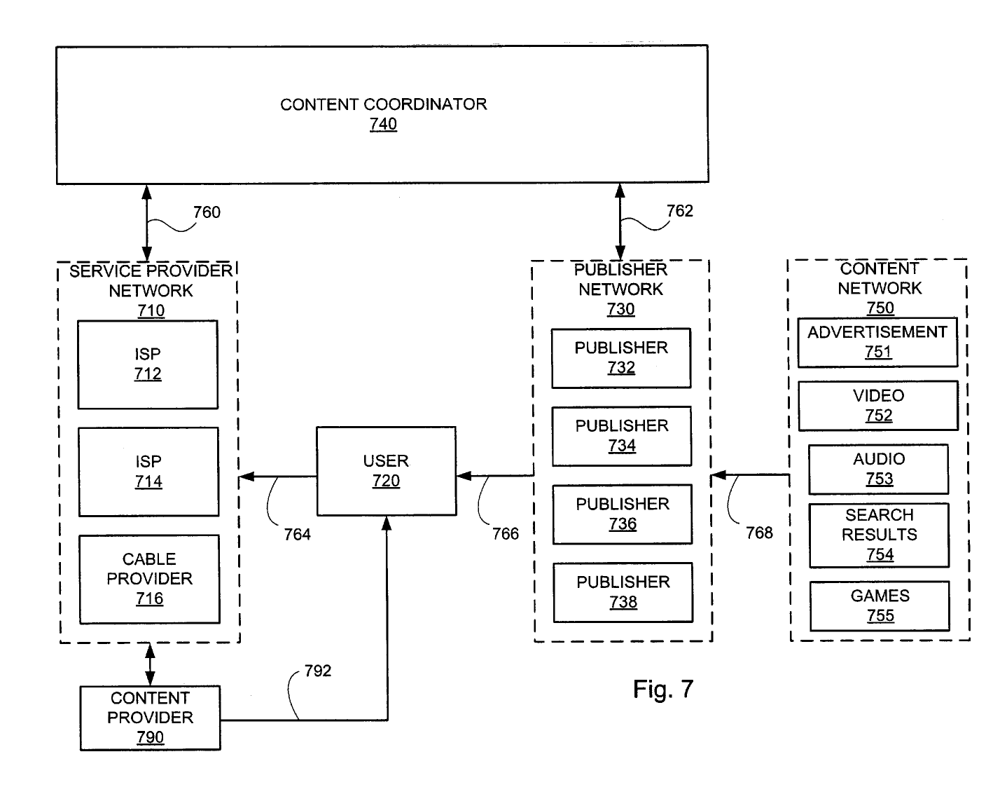

Computing device 10, which may be a client computer device, is operatively coupled with service provider 14 at a network node. One or more client devices may operate at a node as well as one or more applications, information agents, browsers, and/or transferable cookies. Client device 10 may access Internet 12 via service provider 14. As a non-limiting example, service provider 14 may be an internet service provider. As will be described in more detail below, service provider 14 enables client device 10 to access the Internet 12, and may provide various other services. In alternative embodiments, a service provider may enable a client device to access a different network. As will be explained in more detail below, a content provider 16 and content coordinator 18 may also be operatively coupled to and accessible from Internet 12. While only a single service provider, content provider, and content coordinator are shown, it should be appreciated that a plurality of service providers, content providers including publishers, and content coordinators may be interconnected via the internet, thus enabling the sharing of browsing information. More particularly, service providers or other entities may be organized into alliances or other entities acting in concert to obtain and act upon browsing behavior of devices coupled to the Internet as will be described in greater detail with reference to FIG. 7.

For purposes of clarity, the example of FIG. 1 is a highly simplified computer network. It should be understood, however, that targeted content delivery is applicable to internetworked systems of widely varying sizes and complexity. For example, large numbers and different types of client devices may be internetworked to Internet 12 via one or more node communicatively coupled with service provider 14, or through other service providers. The client devices may communicate with any number of content providers or other resources accessible via Internet 12. Further, as will be explained in greater detail below, a plurality of service providers may communicate various marketing specific information between each other and/or between one or more content coordinators.

Computing device 10 includes a browser 20 or like software configured to retrieve and display various types of content which may be found on Internet 12. For example, browser 20 may be configured to request and retrieve web pages. Requested web pages may be constructed from text, images, video, audio, and/or other data residing on the Internet and may be provided by one or more content providers 16. Over time during a particular session, various web pages or other content medium such video, audio, games, etc. may be presented to the user. For example, HTTP requests issued by browser 20 may be sent out to Internet 12 via service provider 14, with corresponding HTTP response data or other suitable data being returned to browser 20 via service provider 14. The response data is then used to construct and display web pages 22a, 22b, 22c, 22d, successively to the user. Alternatively, response data may be used to provide content to the user without necessarily displaying a web page. As one example, internet based television, games, and/or radio may be provided without necessarily requiring a web page being displayed to the user. Continuing with FIG. 1, web page 22a might be called up in response to a user input such as the user typing a Uniform Resource Locator (URL) into browser 20. Web page 22b might then be displayed in response to the user clicking a link displayed on web page 22a. Web pages 22c and 22d would then be presented in response to subsequent HTTP requests.

The content presented on a given web page may come from a single source or multiple sources. For example, a given page might include content such as news, advertising content, or non-advertising content provided by content providers including one or more web publishers. As one example, advertising content may be provided from a site operated by the provider of the goods/services, or from a third party, such as an advertising network, or other sources.

Content may be tailored, for example, by the content coordinator based on the individual user's browsing behavior, so that the content provided to the user are specifically tailored to the user (e.g., selected to match the interests of the individual as analyzed from visited web pages). In addition, it may be advantageous to obtain information about user behavior in an unobtrusive manner, for example without necessarily requiring software to be downloaded and installed onto the user's computer (e.g., client device 10). However, in some conditions software may be downloaded or installed in addition to or instead of the other approaches described herein for enabling improved delivery of targeted content to end users.

Improved end-user targeted content selection and delivery may be accomplished through use of service provider level features. Service provider 14 may be any suitable entity or business that provides a user device, such as client device 10, with access to content, such as via Internet 12. Service provider 14 may support various types of device connections, including dialup, broadband (cable, DSL, etc.), wireless, broadband wireless, satellite, Ethernet, T1, etc. Service provider 14 may have a single discrete point-of-presence or may comprise a large organization with many access points, and may include servers and other hardware such as routers, switches, aggregators, accelerators, etc. Service provider 14 may also provide virtual service provider services such as email, web hosting, DNS services, etc. Service provider 14 may provide content to other user devices besides client device 10. In some examples, for a given device serviced by a service provider (e.g., via device 10), all network traffic for the device can flow through the service provider that provides the device with internet access or other content delivery. However, it should be appreciated that some devices may access the internet or other content delivery network via a plurality of service providers. As will be discussed in more detail below, the service provider may be employed to facilitate delivery of targeted content to connected devices, such as client device 10.

FIG. 2 is an exemplary diagram of a computing device 60 having one or more of the components that may be employed at client device 10, service provider 14, content coordinator 18, content provider 16, etc. to provide one or more of the various functions described herein.

Device 60 may include a bus 62, a processor 64, a memory 66, a storage device 68, one or more input devices 70, one or more output devices 72, and a communication interface 74. The bus 62 may include one or more conductors that permit communication among the components of device 60.

The processor 64 may include any suitable type of processor or microprocessor that interprets and executes instructions. Memory 66 may include a random access memory (RAM) or another type of dynamic storage device that stores information and instructions for execution by the processor 64. Memory 66 may also include a ROM device or another type of static storage device that stores static information and instructions for use by the processor 64. The storage device 68 may include a magnetic and/or optical recording medium and its corresponding drive.

The input devices 70 may include one or more mechanisms that permit a user to input information to the client 60, such as a keyboard, a mouse, a touch screen, a pen, remote control, voice recognition, optical recognition, and/or biometric mechanisms, etc. The output devices 72 may include one or more mechanisms that output information to the user, including a display, a printer, a speaker, etc. The communication interface 74 may include any transceiver-like mechanism that enables the client 10 to communicate with other devices and/or systems, such as to facilitate network communication with Internet 12 through service provider 14.

Various functions are described herein that may be carried out by a device such as device 60. Exemplary device 60 may perform these operations in response to processor 64 executing software instructions contained in a computer-readable medium, such as memory 66. A computer-readable medium may be defined as one or more memory/storage devices and/or carrier signals.

The software instructions may be read into memory 66 from another computer-readable medium, such as the data storage device 68, or from another device via the communication interface 74. The software instructions contained in memory 66 can cause processor 64 to perform processes that will be described below in greater detail. As described herein, software instructions may include computer readable code that may be applied at the client device or alternatively upstream of the client device, for example, by the service provider or content provider via the service provider. Further, hardwired circuitry may be used in place of or in combination with software instructions to implement processes consistent with the present disclosure. Thus, the present disclosure is not limited to any specific combination of hardware circuitry and software.

Referring now specifically to client device 10, the device may be any type of computing device capable of running browser software or other appropriate content access applications, including a desktop computer, laptop, television, radio, handheld computer, mobile telephone, personal digital assistant, etc. Furthermore, the client devices may connect to network 12 from residential, commercial or other locations, such as businesses, hotels, schools, private residences, etc. From these locations, the client devices may be coupled using wired or wireless (Wi-Fi, Wi-Max, GPRS, EDGE, etc.) connections, or other types of connections, and may be connected individually or through local or private networks available at the connecting location. Furthermore, though the present disclosure discusses HTTP traffic in many examples, it will be appreciated that other types of protocols and traffic may be employed in connection with the targeted content delivery described herein. The present system and method may be employed for example, in connection with wireless devices employing WAP protocol.

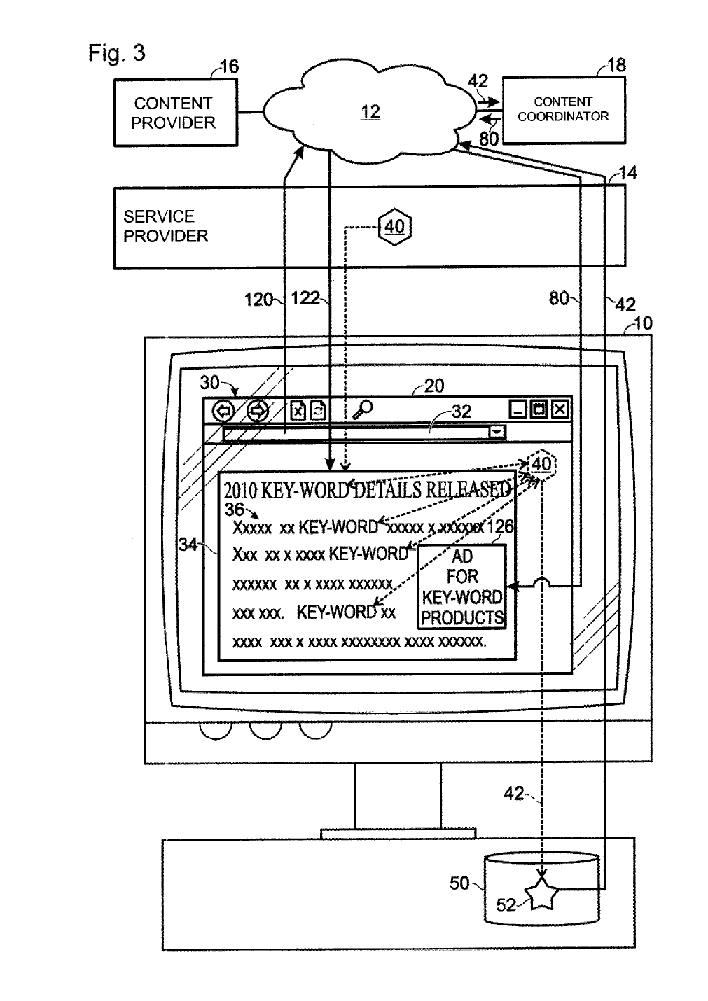

FIG. 3 depicts further aspects of targeted content delivery according to the present description. As in the example of FIG. 1, client device 10, content provider 16 and content coordinator 18 may be coupled to Internet 12, with the internet access of client device 10 being provided by service provider 14. Client device 10 is shown running browser 20, which has user controllable browser controls 30 (e.g., navigational controls such as “forward,” “back,” “stop,” etc.) an address bar 32. An exemplary web page 34 is displayed by device 10, including a presentation/display of web page based content which may be viewed by a user.

As discussed above, it may be desirable for content to be tailored to the end-user. Accordingly, targeted content delivery may include the use of a content reader 40 configured to obtain information about the data requested by and/or delivered to a browsing client device. According to one example, the content reader may be implemented as an instruction set that, alone or in combination with other components, causes an application to launch and operate on the data returned in response to end user HTTP requests or other user requests. The following is a non-limiting example of javascript code that may be used, in whole or in part, to implement content reading of web page data; however it should be appreciated that other computer readable code may be used:

<script type=“text/javascript”><!--
var PSpc=“I.ISP”,PSsize=“popunder,popup,richmedia,tadd”;
// -->
</script>
<script type=“text/javascript”
src=“http://ps.pagesense.com/tag/2.js”></script>

Regardless of the particular code or other implementation, content reader 40 may be configured to obtain browsing information 42 based on end-user browsing behavior. As explained in more detail below, the browsing information is used to enable selection of tailored content that may be delivered to the user or computing device, such as for example, targeted advertising. The browsing information may include information about the content of web pages. For example, for a given web page 34, the browsing information may include: (1) keywords found in web page content 36, such as the depicted “KEY-WORD”; (2) analysis and indexing of words or groupings of words on the web page; (3) frequency of keywords appearing on the page; (4) position of keywords appearing on the page; (5) URL or address of the web page; (6) relative size of the keywords; (7) visual images or symbols; (8) content requested by and/or delivered to the user (e.g. text, images, video, and/or audio, or any other data that may be used to select targeted content). The keywords and other analyzed data may be explicitly presented to the user (i.e., viewable), or hidden or embedded, as in the case of meta tags.

Content reader 40 is not limited to acquiring keyword or other content information pertaining to the currently viewed web page. Indeed, the browsing information may be collected so as to also include historical data pertaining to the browsing performed with device 10. According to one example, content reader 40 may send such historical browsing information to a service provider.

Historical and/or current browser information may additionally or alternatively be tracked by an information agent (e.g. a cookie) at the client device. Such use of locally updated data may enable collection and use of browsing information for multiple web pages requested by the user.

The content reader 40 and/or information agent may track other behavior information such as viewing behavior of on-demand video, audio, or game content. Accordingly, selection of targeted content may be based on historical data, including historical data pertaining to any of the keyword or other data referenced above, patterns of repetition associated with browsing behavior, user preferences, etc. While the various examples provided herein may describe a different functionality with regards to the content reader and the information agent, it should be appreciated that a similar function may be performed by each.

Beyond the particulars of the data in browsing information 42, or the manner in which it is collected, the browsing information may be reported out to content coordinator 18 via service provider 14 and/or Internet 12. Content coordinator 18 may be configured to receive browsing information 42 and use such browsing information to select, for example, advertising content 80 (such as advertisement 82) to be returned to the browser that generated the browsing information. While advertising content is selected in this example, content coordinator 18 can be configured to select and provide other types of content, including specifically tailored versions of the requested content as modified based on observed browsing behavior.

Referring to FIG. 3 and also to FIG. 1, content coordinator 18 may be implemented with one or more storage/memory locations (e.g., a database) containing identifiers 102, categories 104 and content 106. Content coordinator 18 may also include a matching engine 110 configured to process browsing information 42 and data stored at 102, 104 and/or 106 in order to select content to be returned to device 10.

Identifiers 102 may be user identifiers that identify specific client devices and/or end-users of those client devices. For example, cookie 52 may be sent to content coordinator 18 and used to identify client device 10, and thus indirectly identify a user of that device. The identification data within the cookie may be checked against identifier information 102 to determine whether content coordinator 18 had any stored information for that user.

One type of information that may be stored at content coordinator 18 is category information. Any number and type of categories may be established to facilitate selection of targeted content (e.g., advertising content stored in database of content 106). Potential categories include: sports, shopping, travel, real estate, games, automotive, science/technology, etc. A nearly limitless number of categories/subcategories may be established at varying levels of specificity. For example, based on collected browsing information 42, data stored at content coordinator 18 may indicate that a particular user was interested in categories A, B, D and G, while browsing information for another user might indicate interest in categories C, F and D. Matching engine 110 may then apply a ruleset or other schema to select appropriate content-specific advertisements (e.g., stored in location 106) or other content for the respective users based on the interest categories, and/or on other behavior information or criteria. In addition, the system may be configured to deliver one or more versions of default content in the event that the processed browsing information does not yield a match.

In some embodiments, a user may be assigned to different categories depending on the application. For example, a user may be assigned to a first group of categories for use with a social networking application, while the user may be assigned to a second group of categories different from the first group for use with a targeted advertising application. In this way, content that is provided to the user may be varied depending on the application, whether it is social networking, advertising, on-demand video, audio, games, or internet search, among others.

The ruleset or schema used to select the content may be configured in a variety of different ways. In addition to or instead of the category-based selections described above, the ruleset may evaluate factors such as the historic effectiveness of previous advertisements generated or content provided, the advertising campaigns currently offered or available at content coordinator 18, the relative value of such campaigns based on click-through rate and cost per click, the frequency caps on advertisements being shown, the advertising and response history of the individual end-user in question, the short term and long term browsing history of the user and competing eligible advertisements for the particular opportunity. Cost per action may also be evaluated.

For example, an advertiser may pay the party operating the content coordinator a price per customer that completes a transaction (e.g., a customer obtaining a mortgage from a mortgage company whose advertisement was served). This cost per action may be employed to optimize advertising performance and implemented within the ruleset(s) employed by matching engine 110. Based upon analysis of these factors, among others, content coordinator 18 may determine whether or not to send a targeted advertisement to the user. In some implementations, the identity of an individual when browsing behavior is being analyzed may be anonymous.

As described in the above examples, their may be a substantially large variety of different browsing behaviors. For example, each client device may exhibit different browsing behaviors if multiple different users interact with the client device. In some examples, browsing behavior obtained from multiple users accessing the internet via the same client device can be distinguished from each other by use of different login information among each of the users when a single service provider is used or users may access the internet via different service providers. In this manner, behavior among a group of users may be distinguishable, thereby enabling tailored content to be directed to the appropriate user.

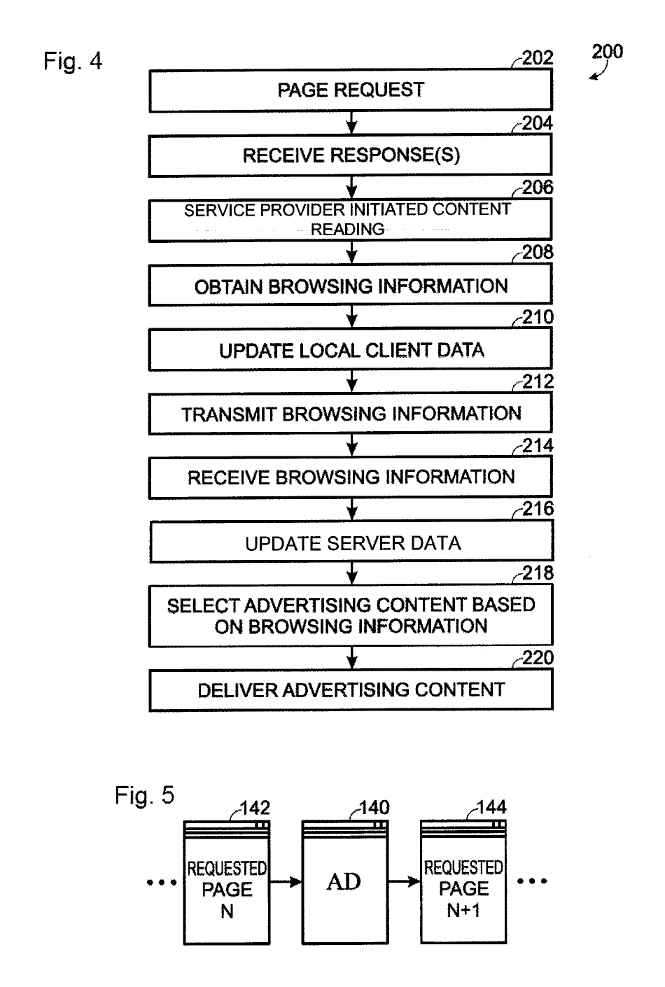

Referring now to FIGS. 3 and 4, further exemplary aspects of targeted content delivery will be described. Exemplary method 200 includes issuing a page request at 202. In the example of FIG. 3, the page request is shown at 120 and may result from a URL being typed into address window 32 of browser 20. Page requests may also be initiated through hypertext linking (e.g. hyperlinks) or other methods. Request 120 may be received at service providers 14 where it may be forwarded out to Internet 12. Method 200 includes, at 204, receiving response data corresponding to the outgoing request. As indicated in the example of FIG. 3, response data 122 is received at service providers 14 and forwarded to device 10, where the response data is used by browser 20 to display content such as web page 34. Response data 122 may come from a single source (e.g., a website) or from multiple different sources. For example, content including images, text, advertising, etc. may be delivered to service provider 14 from one or more content providers coupled to Internet 12.

At 206, the method includes service provider initiation of content reading of the response data received in response to web page requests. The service provider initiation of the content reading function may be performed by causing the content reader to be applied from the service provider to requested web page data. In particular, in FIG. 3, content reader 40 may be stored in a memory location at service provider 14, for example on a server (e.g., a proxy server) or network appliance that manages traffic through the service provider. In the present example, content reader 40 is a javascript that is embedded or injected by the service provider into response data 122, for example by the proxy server. As a result, the javascript (content reader 40) is embedded into web page 34. In some implementations, the script may be embedded into each of a plurality of web pages or other content that are requested by and/or delivered to the client device.

Alternatively, the content reader may be included in content that is sent to the browser. For example, a content coordinator may embed content-reading javascripts into content that is sent to a browser or included in or on content such as web pages requested by the browsers. Then, at the browser, the content reader may obtain browsing information from the client (e.g., from a requested web page), and the browsing information may then be used to select content. In this case, the initial advertisement may serve as the mechanism by which the content reader is delivered to the browser in order to obtain the browsing information.

Referring again to FIG. 4, at 208, the method may include obtaining browsing information. In the example of FIG. 3, the javascript may be executed within memory of device 10 to obtain browsing information associated with web page 34. As shown, the script may read and locate keywords on the displayed page, and/or perform other content-reading operations, as described herein.

At 210, the method may include updating locally stored data at the client device. In FIG. 3, for example, the javascript may set cookie 52 or otherwise store or update locally stored browsing information in memory/storage location 50.

At 212, the browsing information obtained from the service provider initiated content reading may be transmitted or reported out, so that it can be used to generate targeted content. In FIG. 3, the javascript causes browsing information 42 to be transmitted out to Internet 12 via service provider 14. The reporting of the browsing information may include, for example, transmission of cookie 52.

Alternatively, the actual content reading function may be performed at the service provider, instead of on web pages displayed on the browser or via other content. Content including browser-requested data may be copied to a memory/storage location within the service provider (e.g., on a server). The copied data could then be analyzed to obtain browsing information, which would then be used as described herein to perform selection and delivery of targeted content.

For example, the service provider may include a proxy server that manages routing tables and assembles and/or parses data packets flowing between client devices and the internet. The proxy server may include an application that performs a content-reading or monitoring function on data requested by the connected client devices. Based on analysis occurring at the proxy server, the proxy server may modify client-requested data it receives so that targeted content (e.g. advertisement) appears on a web page requested by a client. Additionally or alternatively, the proxy server may send out the results of its content analysis to another location on the internet, such as content coordinator 18, so that the browsing information acquired at the service provider may be used at the remote location to procure targeted content.

As will be described in greater detail below with reference to FIG. 7, in some embodiments, a network of one or more service providers may utilize the content reading function as described above, wherein browser-requested data may be copied to a memory/storage location within each of the participating service providers (e.g., on one or more servers) or submitted to a common location such as a content coordinator for processing and redistribution. The data may then be shared with and/or compared to data obtained by other service providers and members of the network, thereby potentially improving the analysis of browsing information and delivery of user specific content.

As explained above, the content reader may be configured to utilize more than just keyword and other data pertaining to a given web page. The content reader may also include behavioral data relating to various other content (e.g. browsing behavior, viewing behavior, user selection, etc.), other historical data collected over time, demographic data associated with the user, IP address, URL data, etc.

Referring still to FIG. 4, the method may also include, at 214, 216, 218 and 220, receiving the browsing information, updating server data, and selecting and delivering content based on the browsing information. In the example of FIG. 3, browsing information 42 transmitted through service provider 14 and Internet 12 may be received and acted upon at content coordinator 18. Cookie 52 may be referenced against identifier information 102 (FIG. 1) to determine if content coordinator 18 includes a record associated with the requesting device (e.g., device 10) or user. Information stored locally on content coordinator 18 may then be updated with the transmitted browsing information. In some implementations, the quantity of data stored for a particular device/user at content coordinator 18 may be larger than that stored locally within cookie 52. Cookie 52, for example, might include browsing data for only a few web pages or a portion of the content requested and therefore may contain only a relatively small amount of data. Content coordinator 18, on the other hand, may store relatively larger amounts of data associated with the particular user/device. Further, the amount of data obtained and/or selectively stored by content coordinator 18 may be increased when receiving and/or sharing browsing information from a plurality of service providers each of which may be hosting one or more users. In some embodiments, the cookie or other information agent can handle larger amounts of data.

The browsing information (whether derived from cookie 52 only, or from a combination of the cookie and already-existing data in content coordinator 18 for the user/device) may then be used to select content. Based on the browsing information, matching engine 110 may identify/select a targeted advertisement. This may involve, as previously described, using category or channel information 104 (or other criteria in the ruleset(s)) to select an appropriate advertisement from the inventory of advertisements stored in 106. In the present example, targeted content 126 has been selected and delivered to browser 20, in part based on the presence of certain keywords on web page 34. As described above, keyword frequency, position, and a wide variety of other browsing information may be employed in execution of rulesets to select the appropriate targeted content.

In some cases, a person's browsing behavior, which may be generally indicative of their personal interests and/or preferences may vary with time. Similarly, a client device may be used by different users, which may also vary with time. As such, in some embodiments, various time dependent selection approaches may be used (e.g. by the content coordinator or other member) to facilitate improved selection of targeted contented based on the obtained behavior information. In one approach, browsing information derived from the activity of a user and/or a particular client device may be interpreted and/or adjusted using a moving average approach. In a non-limiting example, a 200 day moving average (DMA) may be considered by matching engine 110 in order to provide more relevant information regarding past or aggregate browsing behavior responsive to the last 200 days of browsing activity. While a 200 DMA example is provided herein, other time windows may be used such as one or more minutes, hours, days, or years. Further, the consideration of a moving time window for selecting content may include the use of linear and/or exponentially weighted averaging. For example, recently acquired or time dependent browsing information may be assigned a greater weighting in the moving average calculation, while less recently acquired or time dependent browsing information may be assigned less weighting. In this manner, the relevancy of the browsing information being considered may be improved, thereby improving the relevancy of the selected and/or delivered content.

The selected content may be presented to the user in a variety of ways. According to a first example, the content may be returned to the browser and display or presented on the web page that generated the browsing information which caused selection of the content, as in FIG. 3. In another example, the content is returned and displayed without reference to the current page in the browser window. For example, tailored advertisements may be provided at any time to browser 20, based on monitored browsing behavior, regardless of whether those advertisements pertain to the currently-displayed content in the browser or whether they were specifically requested by the user.

In another example, as shown in FIG. 5, tailored content may be presented as a bridge or transition advertisement 140, which is presented between requested pages 142 and 144, and independently of any web page or other content specifically requested by the browser. According to one implementation, browsing information received at content coordinator 18 includes URL information, which may include addresses of pages requested by the browser. Based on these addresses, a targeted advertisement may be selected at content coordinator 18 and presented in this independent manner between requested web pages. More particularly, a bridge/transition advertisement may be selected based on the URL that the browser is leaving and/or the target URL that the browser has requested to display next.

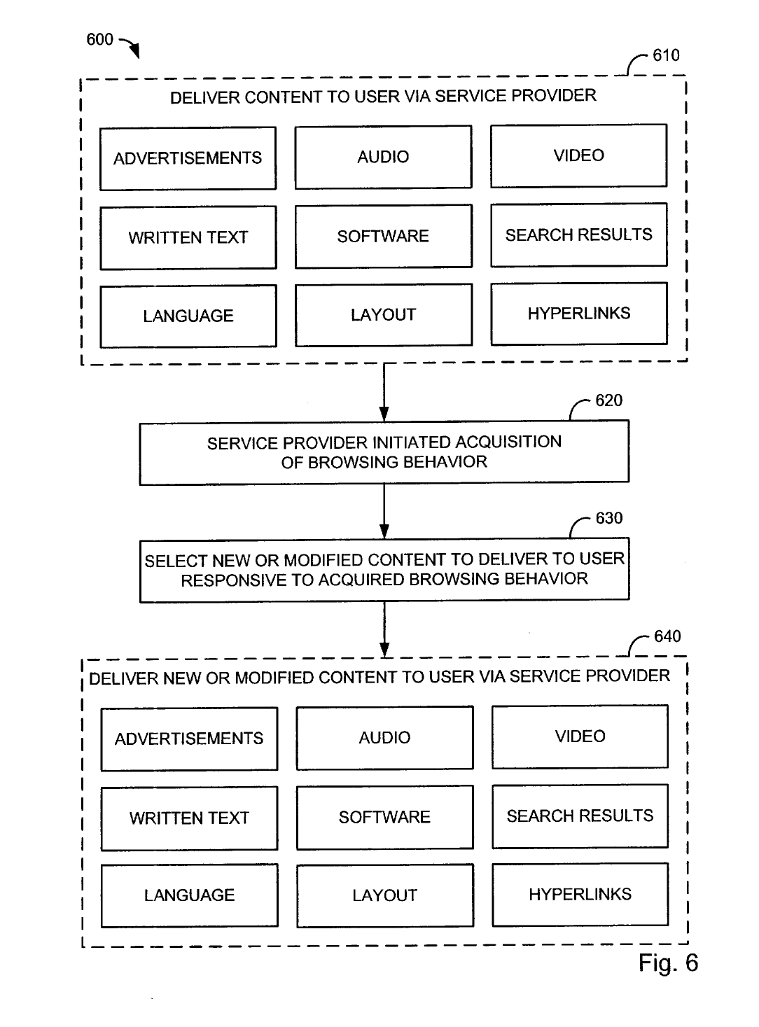

While some of the approaches described above are generally applied to the delivery of advertisement content, it should be appreciated that any content provided to a user via a computing device may be varied responsive to the detected behavior of the user. FIG. 6 provides an exemplary method 600 for delivering content to a user based at least partially on browsing behavior obtained by one or more service providers. At 610, content may be delivered to a user via at least one service provider. Content may include advertisements, audio, video, written text, software, search results, hyperlinks, games, etc. Further, content may be provided in different languages and in different layouts including text size, font, color, arrangement, etc.

At 620, information relating to the user response (e.g. browsing behavior) to the delivered content of 610 may be acquired by the service provider (e.g. via a javascript) as described above. At 630, new or modified content may be selected for delivery to the user responsive to the acquired browsing behavior. Virtually any content, whether visual (e.g. text, symbols, colors, images, video, symbols, page configuration, ordered search results, etc.) or aural (e.g. sounds, music, dialog, etc.) may be varied to appeal to (or affect) a user. In this way, user interaction and response to a web page or group of web pages may be varied by varying the content delivered to the user via the computing device. For example, a web page may have a plurality of versions, wherein a user having a particular browsing behavior may be presented a first version while a user having a different browsing behavior may be presented a second version. Even if the web page does not have different versions, the web page can be modified so as to be specifically tailored based on observed browsing behavior.

At 640, the new or modified content may be delivered to the user via the service provider including new or modified advertisements, audio, video, text, software, search results, hyperlinks, layout, language translations, etc. The example method 600 may be repeated such that user response to the new and/or modified content provided to the user may be acquired by the service provider and used for selecting a second generation of new or modified content. In this manner, an iterative approach to content selection may be provided, thereby improving the likelihood of achieving the desired user response to the selected content.

As one example approach for applying the targeted content delivery described above, a user may be provided advertising content relating to a school where the user may take classroom courses in graphic arts. If the user responds to the advertising content, for example, by browsing the content associated with the advertisement, then graphic arts related content not specifically requested by the user may be provided to the client device. For example, a software program stored locally or remotely on the user's client device may be automatically updated with new or modified content to present the user with drawing tools associated with the graphic arts activity when the software program is used. In another example, search results relating to graphic arts topics may be preferenced when presented to the user.

While FIG. 6 describes content provided via the service provider, it should be appreciated that new or modified content (e.g. computer readable code) may be provided via instructions from the server derived from original content plus past browsing behavior stored in the system. For example, a software program residing in memory on the computing device may be configured to provide new or modified content responsive to browsing behavior acquired by the service provider, without necessarily requiring that the new or modified content be provided by the service provider. In at least one approach, acquisition of browsing behavior as initiated by a service provider may interact with third party applications (e.g. software applications) of the computing device to provide new or modified content, features, menus, etc. to the user. Thus, the software application may be configured to perform operations 620, 630, and 640 described above without additional input from the service provider, at least in some examples.

While some of the examples provided above have related to browsing information acquired by a single service provider, a network of members including multiple service providers, publishers and/or content providers may be formed to provide greater acquisition of browsing behavior and more relevant content selection. In some embodiments, the sharing of information between members of the network may be facilitated by one or more common protocols, enabling a first member to submit user behavior information via a prescribed format to a common location where it may be processed and redistributed to one or more members of the network. Each of these members may in turn use the processed information for selecting and/or modifying content that may be provided to the user.

In some embodiments, an alliance or network of service providers may work collectively to gather browsing information of a plurality of users. FIG. 7 depicts a non-limiting example of a network for providing targeted content to a user responsive to the behavior of the user. A user 720 may subscribe to at least one of a plurality of service providers shown herein as a service provider network 710. Service provider network 710 may include one or more service providers such as one or more ISPs, cable providers, telephone providers, wireless providers, or other telecommunication providers shown in FIG. 7 generally as 712, 714, and 716. As described above with reference to FIG. 3, browsing behavior of user 720 may be transmitted through at least one service provider via 764 by a content reader. Content may be provided to user 720 from content provider 790 via 792 and/or a publisher network 730. It should be appreciated that FIG. 7 schematically shows one non-limiting example of the various relationships that may exist between users, content providers including publishers, service providers, and content coordinators and may therefore not necessarily identify the actual path in which data is transmitted.

A content coordinator 740 may form a partnership with service provider network 710, such that information retrieved via a content reader may be passed on to media organization 740 via 760, where it may be stored, processed, used for content selection, retransmitted, etc.

Further, content coordinator 740 may form a partnership with a network of publishers (e.g. content providers) 730, wherein the information relating to the browsing behavior of user 720 may be provided via 762 to one or more publishers as to enable a selection of content from content network 750 via 768. The publisher network may include one or more publishers such as 732, 734, 736, and 738 and may include advertisers, businesses, media organizations or other entities. Similarly, content network 750 may include a plurality of different content that may be presented to user 720 by members of the publishing network. Content may include advertisements 751, video 752, audio 753, search results 754 and/or games 755; however other types of content as described herein may be provided to the user by the publisher network via 766.

In this manner, information derived from the behavior of user 720 may be shared among members of the network. It should be appreciated that user 720 may be one of a plurality of users, wherein information derived from the behavior of each of the users may be shared among the network of service providers and/or publishers, enabling an improved selection of content.

As described above with reference to FIG. 6, content may include results of a search query request that may be initiated by a user via a client device including, for example, a browser. The results displayed to a user from a search request may be varied responsive to the past browsing behavior of the user. In one approach, the order or ranking of the search results may be varied to accommodate the preferences of the user. For example, a user that has a past browsing behavior suggesting an interest in a particular music genre may be presented search results favoring the particular music genre when a general or broad search of many music genres is performed. In this manner, the relevancy of the results of a requested search may be improved under some conditions, thereby potentially increasing the likelihood that the user finds and/or purchases what is being sought.

In another approach, results of a search request based on one or more keywords having multiple potential meanings may be more or less favored in the ranking of the resulting search based at least partially on past browsing behavior. Keywords that include acronyms, proper names, etc. may represent multiple objects that may return irrelevant results to a user, potentially causing frustration at the search process. Thus, a user searching, for example, for a relatively obscure sports athlete by proper name may not receive or may receive less relevant search results of an unrelated person such as a politician having a similar proper name. In this manner, the relevancy of the search results may be improved based on the user's specific preferences as predicted from their past browsing behavior.

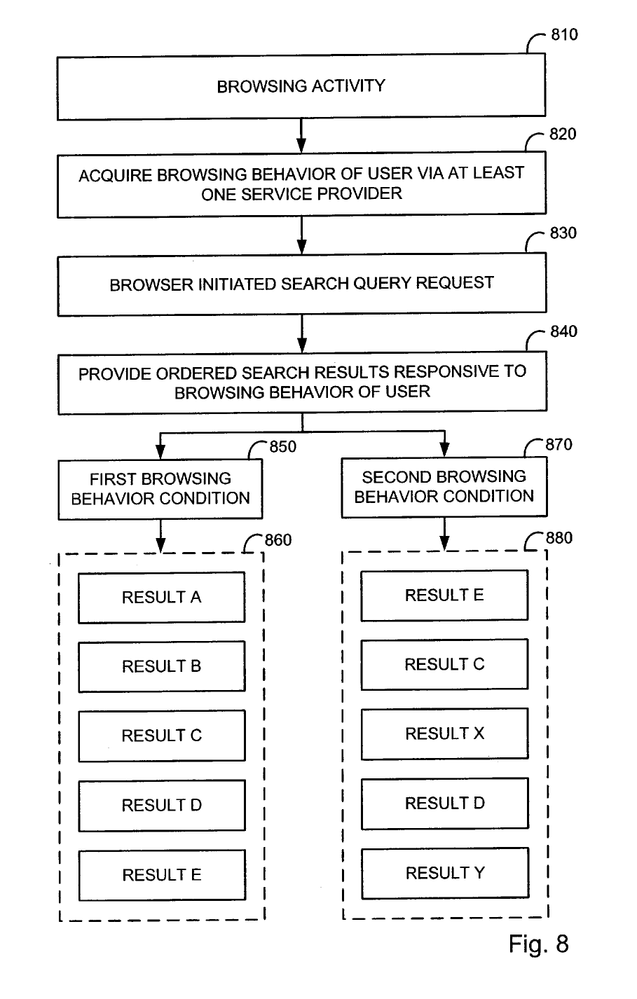

FIG. 8 shows an example implementation of the approach described above. Browsing behavior of a user's browsing activity at 810 may be acquired at 820 via a service provider. At 830, a user may initiate a search query request via a browser, which may include a keyword search, for example. At 840, ordered search results may be provided to the browser responsive to the acquired browsing behavior. For example, responsive to a first acquired browsing behavior shown at 850, the results displayed on the browser may include at 860 results A, B, C, D, and E as shown in their respective order. Alternatively, responsive to a second acquired browsing behavior at 870 different from the first browsing behavior at 860, the results displayed on the browser may include results E, Y, X, D, and C, respectively.

Therefore, the results of a search query may include different content, for example, results A and B are included in the search results provided responsive to the first browsing behavior while results X and Y are included in the search results provided responsive to the second browsing behavior. Further, as shown in FIG. 8, the order of the displayed results may vary based on the acquired browsing behavior. For example, result E is shown having a higher ranking or ordered higher in the search results provided to the browser based on the second browsing behavior than the first browsing behavior, while result C is shown having a lower ranking in the search results based on the second browsing behavior than the first browsing behavior. Further, result D is shown having a similar ranking in both browsing behaviors.

In some embodiments, the interconnectivity of a plurality of web pages or other content provided to the browser may be varied in response to past browsing behavior. In one approach, a web page may be linked to a family of web pages having similar or dissimilar content. A first user exhibiting a first browsing behavior may be directed to a first web page, while a second user having a second different browsing behavior may be directed to a second web page. For example, an advertisement having a link to a web page where a charitable donation may be submitted may direct a first user having a past browsing behavior indicative of their interest in environmental conservation to a web page enabling the first user to contribute to an environmental conservation charity. A second user having a past browsing behavior indicative of their interest in a local charitable organization may instead be directed to a web page enabling the second user to contribute to the local charitable organization. In this manner, a single link can create multi-story branching based at least partially on the past browsing behavior of the user.

Other types of content delivered to the computing device including internet television, on-demand video/audio, and/or online gaming can also be varied responsive to the obtained browsing behavior. With respect to on-demand video, audio, and games, browsing behavior may include viewing behavior, for example, representative of the amount of time a particular video, audio, and/or game is viewed, the amount of data relating to the selected video, audio, or gaming content that is requested or delivered to the client device, the type of video, audio or game content that is selected, the game aptitude of a user playing the game, etc. While viewing behavior is at times described herein separately from browsing behavior, it should be appreciated that viewing behavior may be a subset of browsing behavior.

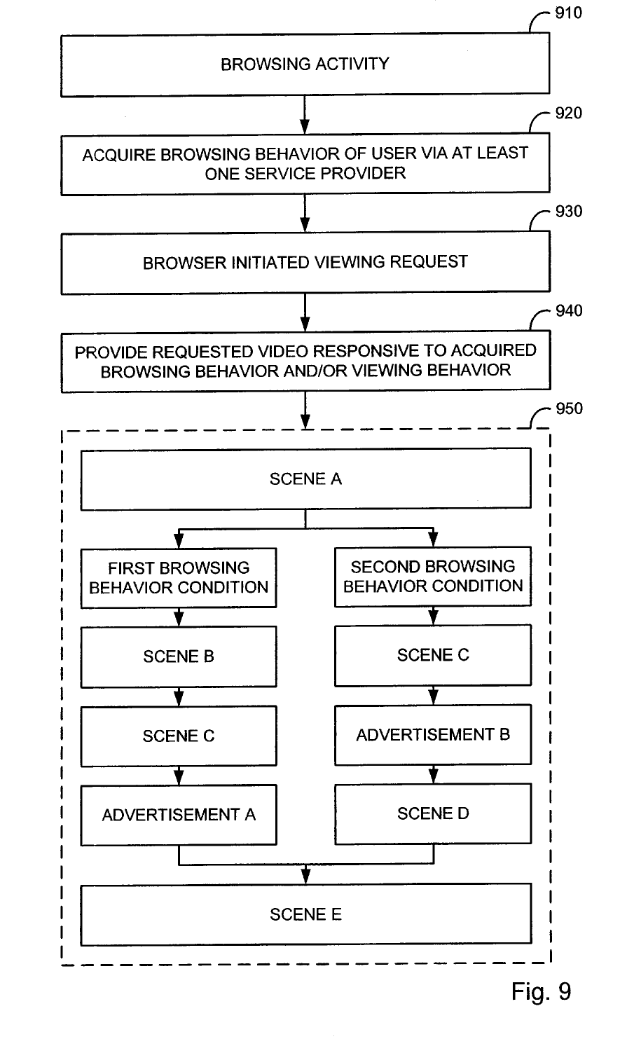

FIG. 9 shows an example implementation where a multi-branching approach may be used to provide a different user experience based on behavior information acquired by the service provider. Browsing behavior and/or more specifically viewing behavior of a user's browsing activity at 910 may be acquired at 920 via an ISP initiated content reader as described above with reference to FIG. 1. The behavior information obtained by the content reader may include an aggregate of information from a past history of browsing and/or may include behavior information acquired in real-time. At 930, the user may initiate a viewing request via the browser or other menu system, such as for example, a television guide channel. The viewing request may include a request for an on-demand video, audio, and/or game. In this example, a user has requested a particular video which may or may not include accompanying audio content. At 940, the requested video content may be provided to the client device via the service provider responsive to the acquired browsing behavior. For example, as shown in 950, a particular portion or scene of the video described as Scene A may be provided to all users irrespective of their browsing behavior, while in response to a first obtained browsing behavior, a subsequent Scene B and Scene C may be provided to the client device, respectively. However, responsive to a second browsing behavior different from the first browsing behavior the content provided to the user's client device may include a subsequent Scene C and Scene D, thereby skipping Scene B. In this manner, a user may view different versions of a video based on their browsing and/or viewing activity.

Further, advertisements may be included within video, audio, or game where the advertisement selected for inclusion is based on browsing and/or viewing behavior of the user. For example, as shown in 950, advertisement A may be included in the video provided to the computing device after scene C in response to a first browsing behavior, whereas a different advertisement shown as advertisement B may be included after scene C in response to the second browsing behavior. Finally, it may be possible for the various branches of the video content to be recombined, shown in 950 as scene E. While only two branches (i.e. two versions) of a video are described in the above example, it should be appreciated that there may be any number of branches and/or advertisements that may be tailored for the particular user.

As one example application of the above approach, viewing behavior associated with a user more frequently selecting and/or more often viewing a sports channel may be provided advertising content direct toward sports related products. Further, if it is determined from browsing behavior that the user prefers a particular sport, then the multi-story branching approach may be used to provide more content relating to the particular sport. As another example, browsing and/or viewing activity indicating the user to include a young child may result in a reduction in the amount of violence and/or profanity that is provided to the client device (e.g. the potentially offensive content may not be included or reduced). In this way, by selectively providing content in the form of on-demand video, audio, and/or games to a user based on an aggregate of information and/or real-time information of their behavior, it may be more likely that the requested content will be enjoyable to the user.

Similarly, online gaming or on-demand games may utilize the multi-story branching approach described above to provide different characters, scenarios, challenges, menus, etc. that may be tailored to a particular user. As one example approach, portions of a computer readable code residing locally on the client device or downloaded from the internet via the service provider may be used to modify various aspects of the game. For example, a character of a game may be replaced by a different character based on behavior information of the user or client device, wherein the code for replacing or modifying the character may be downloaded from one or more content providers via the service provider. Further, advertising in games may also be varied based on the browsing behavior of the user as described above.

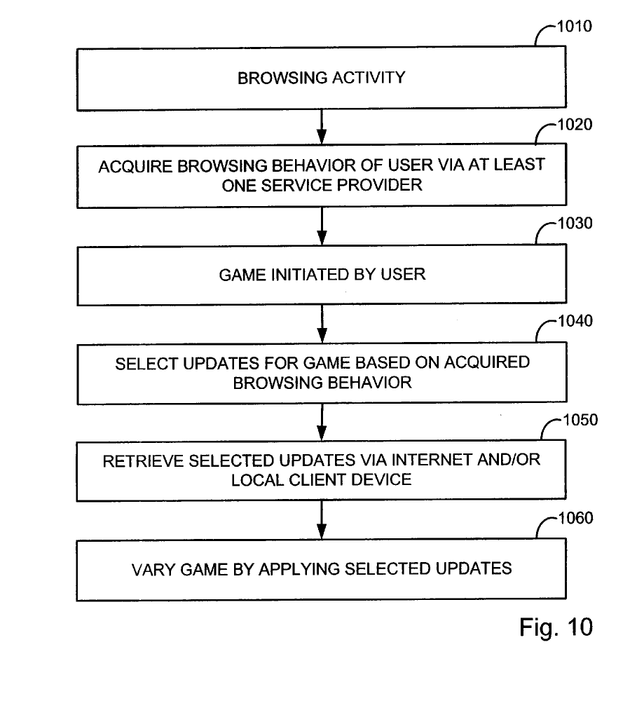

FIG. 10 shows an example implementation where a multi-story branching approach may be used to modify a game based on behavior information acquired by the service provider. Browsing behavior and/or more specifically viewing or gaming behavior of a user's browsing activity at 1010 may be acquired at 1020 via a service provider initiated content reader. At 1030 a user may initiate or select a game to be played on the client device. Such initiation may include transfer of data between the client device and the internet or a content provider via the service provider. Further, portions of the data used to operate the game may reside locally on the client device. At 1040, updates for the game may be selected by portions of the game code residing locally on the client device or may be selected by the content coordinator, service provider, game administrator or other network member. As described above, updates may results in different characters, levels, menus, advertisements, etc. being available or displayed in the game. At 1050, the selected update may be retrieved. If the update is located locally, the client device may access the particular code associated with the update. Alternatively, portions of the code responsible for enacting the game update may be accessed remotely upon a request from the client device. For example, code relating to an update for modifying a character of the game may be downloaded from a content provider. At 1060, the update may be completed, for example, by applying or replacing portions of the games computer readable code with the updated code. In this manner, a game that is played on the client device may be modified in response to browsing behavior of the user.

In some embodiments, behavior information acquired via one or more service providers may be used to facilitate social networking. As described above, users may be assigned among one or more categories based on their particular browsing behavior. As one example, users of a social network accessible via their client device may be able to view, search for and/or contact other users that are assigned to similar categories. Users having similar assigned categories may be preferenced by a matching algorithm (e.g. performed by the content coordinator or other network member). For example, a first user may be able to view the assigned categories of a second user when determining whether to engage the second user in a social networking event. As another example, a first user and a second user sharing at least one assigned category may be selected by a matching algorithm from a plurality of users for an encouraged introduction.

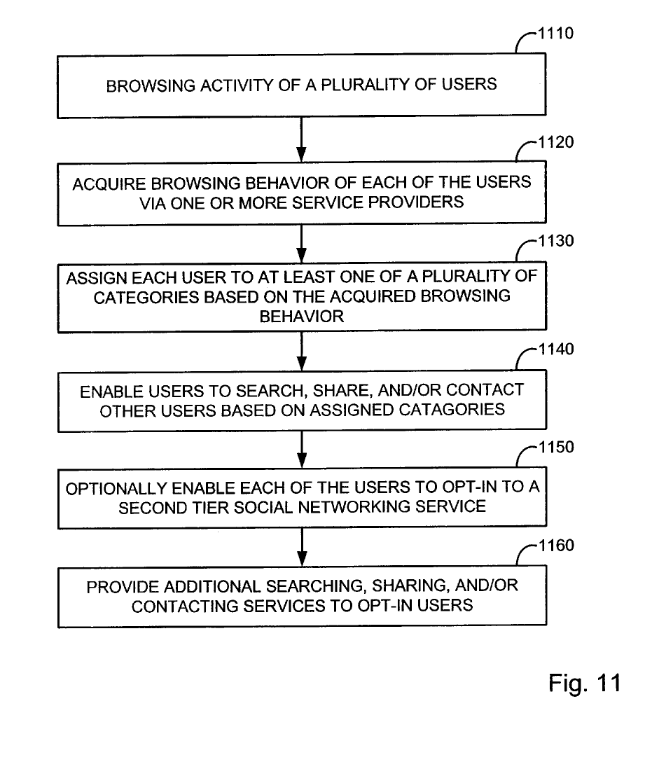

FIG. 11 shows an example implementation where browsing behavior may be used to facilitate social networking. Browsing behavior of a plurality of user's browsing activity at 1110 may be acquired at 1120 via one or more service providers. At 1130, each of the users may be assigned to at least one of a plurality of categories based on the acquired browsing behavior. For example a first user may have browsing behavior indicative of an interest in sports may be assigned to a sports category, while a second user may have an interest in art and may be assigned to an art category. At 1140, the users may utilize the social networking service to enable, for example, searching, sharing of information among other users, and/or contacting of other users based at least partially on the assigned categories. For example, a user that is assigned to a sports category may be able to search for and contact other users assigned to the sports category. In this manner, users having similar interests and preferences based on browsing behavior may be more readily identified by the user, thereby improving the social networking activity.

In some embodiments, a user may be provided greater social networking capability if they choose to opt-in to a second tier of the social networking service. For example, at 1150, the users may be optionally prompted to enter or opt-in to a second tier of the social networking service, wherein at 1160, the users that opt-in may be provided additional searching, sharing and/or contacting services with regards to other opt-in users. However, it should be appreciated that the examples provided with reference to FIG. 11 do not necessarily require that the users opt-in to the social network in order to participate in the various social networking services.

From the above, it will be appreciated that there are many potential advantages to service provider level monitoring of network traffic. Moreover, some of these potential advantages may be obtained through anonymously-gathered information, that is, through anonymously gathering current web page information, browsing behavior, browsing history, browsing configuration, IP address, etc. Listed below are further exemplary applications of the described targeted content delivery.

Service Provider Churn Rate Reduction: The described system and method may be employed to target likely service provider defectors (user's whose browsing behavior indicates they may discontinue the service provider subscription) with targeted promotional messaging. Customers leaving to competitor service providers may be targeted with competitive offerings or other targeted content.

Security/User Protection Applications: Browsing information may indicate that the user is attempting to access a phising site, malware download site, or other undesirable location. The browsing information may be employed to trigger a warning from the service provider, displayed through the browser, that the website is undesirable.

Advertising on Home Page/Portal: As discussed above, advertisements may be shown on a portal or other web pages based upon user history and page content. This approach may be integrated seamlessly with other advertising relationships on a pre-emptive basis. For example, the user comes to the service provider home page, having just browsed for a mortgage. Instead of showing an untargeted advertisement, the service provider initiated content reading causes a high value mortgage advertisement to be shown in the same space.

Targeted Advertising Presented Between Third Party Sites Outside of Home Page/Portal: As discussed above, advertising content may be presented interstitially between domains, enabling the service provider to exert a higher degree of control over the user experience. For example, the user's browsing may suggest that he/she is an excellent potential buyer for a 5 series BMW. As the user leaves one site, and prior to arriving at another, a rich media bridge advertisement is shown for BMW. Or, having visited a number of DVD and movie sites, a user is presented with an advertisement for an online movie rental service while moving between two domains (e.g., URLs).

High Bandwidth Usage: Proposals have arisen to charge “tolls” or elevated access fees to users attempting to access high traffic portions of the internet. The present system and method allows for high bandwidth usages to be more efficiently funded through effective targeted advertising. For example, a user browses to a music site and downloads a large file. The service provider may use the acquired browsing information to obtain knowledge of this behavior and cause a 15 second promotional music spot to be returned to the client, thereby funding the high bandwidth usage of the download.

Multiple Versions of a Web page: The content of a web page including advertisement or non-advertisement information may be varied responsive to past browsing behavior. For example, it may be determined through past browsing behavior that a user has a relatively short attention span for a specific type of content or a particular level of detail of the provided content, and may have increased attention span for other types of content and/or level of detail, etc. Thus, the level of detail, the order that the content is presented, the size of the text, the proportion of text, images, video, and/or audio provided, and the content itself may be varied to better accommodate the user's preferences as predicted from past behavior.

Inter-Service Provider Exchange: As described above, information on browsing behavior of a plurality of users and/or computing devices may originate from different service providers. In one approach, the server system described above may receive information relating to browsing behavior from a plurality of service providers. This information may be shared for example between service providers, advertising agencies, content providers, etc. so that the plurality of users having different browsing behaviors may be organized into categories or classifications. These classifications may be used to provide better predictions and/or content selection among specific preference or behavior categories, since more accurate predictions may be achieved with a greater amount of data. Further, large scale behavior trends among users may be determined or predicted by comparing the browsing behavior of a relatively large number of users having similar or different browsing behavior, thus enabling improved marketing and/or advertising campaigns.

It will be appreciated that the embodiments and method implementations disclosed herein are exemplary in nature, and that these specific examples are not to be considered in a limiting sense, because numerous variations are possible. The subject matter of the present disclosure includes all novel and nonobvious combinations and subcombinations of the various intake configurations and method implementations, and other features, functions, and/or properties disclosed herein. Claims may be presented that particularly point out certain combinations and subcombinations regarded as novel and nonobvious. Such claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for a service provider to target content delivery to a network node based on information requests from the network node, the method comprising:
receiving a content request from the network node;
facilitating delivery of requested content to the network node responsive to the content request;
requesting selection information from a different service provider at least in part by reporting to the different service provider one or more characteristics of the requested content;
receiving selection information from the different service provider; and
facilitating delivery of targeted content to the network node, where the targeted content is selected based at least in part on the selection information received from the different service provider.

2. The method of claim 1, further including embedding a content reader in the requested content, the content reader being adapted to report the one or more characteristics of the requested content to the service provider.

3. The method of claim 2, where the content reader includes computer executable code.

4. The method of claim 3, where the computer executable code includes a javascript.

5. The method of claim 1, further including receiving information from an information agent operating at the network node, the information agent being adapted to report the one or more characteristics of the requested content to the service provider.

6. The method of claim 5, where the information agent includes computer executable code.

7. The method of claim 6, where the computer executable code includes a cookie.

8. The method of claim 1, where the targeted content includes content that supplements the requested content.

9. The method of claim 1, where the targeted content includes advertisements.

10. The method of claim 1, where the targeted content includes modifications of the requested content.

11. The method of claim 1, where the targeted content is not specifically requested at the network node.

12. A computer readable medium, comprising: instructions that cause a service provider to target content delivery to a network node based on information requests from the network node by allowing the service provider, upon execution of the instructions, to:
receive a content request from the network node;
facilitate delivery of requested content to the network node responsive to the content request;
request selection information from a different service provider at least in part by reporting to the different service provider one or more characteristics of the requested content;
receive selection information from the different service provider; and
facilitate delivery of targeted content to the network node, where the targeted content is selected based at least in part on the selection information received from the different service provider.

13. A method for a service provider to target content delivery to a network node based on content requests at the network node, the method comprising:
receiving a plurality of content requests from the network node;
facilitating delivery of requested content to the network node responsive to the plurality of content requests;
analyzing the plurality of content requests; and
facilitating delivery of targeted content to the network node, where the targeted content is selected based on the analysis of the plurality of content requests.

14. The method of claim 13, where the targeted content is not specifically requested at the network node.

15. The method of claim 13, where analyzing the plurality of content requests includes embedding a content reader in the requested content, the content reader being adapted to report one or more characteristics of the requested content to the service provider.

16. The method of claim 15, where the content reader includes computer executable code.

17. The method of claim 16, where the computer executable code includes a javascript.

18. The method of claim 13, where analyzing the plurality of content requests includes receiving information from an information agent operating at the network node, the information agent being adapted to report one or more characteristics of the requested content to the service provider.

19. The method of claim 18, where the information agent includes computer executable code.

20. The method of claim 19, where the computer executable code includes a cookie.

21. The method of claim 13, where analyzing the plurality of content requests includes analyzing content that is requested at different times.

22. The method of claim 13, where the targeted content includes content that supplements the requested content.

23. The method of claim 13, where the targeted content includes advertisements.

24. The method of claim 13, where the targeted content includes modifications of the requested content.

25. A computer readable medium, comprising: instructions that cause a service provider to deliver targeted content to a network node based on content requests from the network node by allowing the service provider, upon execution of the instructions, to:
receive a plurality of content requests from the network node;
facilitate delivery of requested content to the network node responsive to the plurality of content requests;
analyze the requested content; and
facilitate delivery of targeted content to the network node, where the targeted content is selected based on analysis of the requested content.
